(19) United States
(12) Patent Application Publication
(10) Pub. No.: US 2004/0250140 A1
(43) Pub. Date: Dec. 9, 2004

(54) Identifying users of network environments

(75) Inventors: Ira L. Chavis, Wappingers Falls, NY (US); John C. Dayka, New Paltz, NY (US); Frank J. DeGilio, Poughkeepsie, NY (US); John C. Jones, Marietta, GA (US); Sean Lee, New York, NY (US); Hilon R. Potter JR., Poughkeepsie, NY (US); Paul J. Wanish, Poughkeepsie, NY (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 10/428,664

(22) Filed: May 2, 2003

(51) Int. Cl. H04L 9/00

(52) U.S. Cl. 713/202

(57) ABSTRACT

A user identification capability for network environrnents. A user's identity is created using information provided by a user, as well as information provided by a third party, such as an internet service provider, a business, a service, an access device, etc. The identity is used to determine the context in which a user is accessing a process, such as a server, application, network entity, firewall, router, etc.

### TECHNICAL FIELD

This invention relates, in general, to network environments, and in particular, to identifying users of network environments.

### BACKGROUND OF THE INVENTION

In a network environment, users identify themselves to servers using a number of different techniques including, but not limited to, user id and password, and digital certificates. While these techniques are useful, they are not comprehensive. There are environments in which further information is desired. For example, in environments in which multiple organizations within one or more companies share data (e.g., business partners), more granular qualification of user identity information is needed. As examples, information regarding a user's business affiliation, a user's address or physical location in one or more of the organizations is desired. In such environments, a single user (or employee) may have mutually exclusive roles or job functions which are dependent on where or from which enterprise the user is presently working. Thus, in these environments, where a single user may have mutually exclusive roles depending on where the user is working, the single user identity is to be more flexible to support a context within each session.

A prevalent technique for providing this is by having multiple systems that recognize identities mapped from a single distinguished name residing in a user registry. In the X.500 architecture, the user's name is the X.500 distinguished name (DN). If an X.500 compliant directory is used as a platform neutral user registry, users of the compute resources may be denoted by their X.500 DN. However, not all computing systems support the use of an X.500 compliant directory as a user registry. For example, computing systems may have a registry, which is associated with either an application or the underlying operating system platform, which may not adhere to the X.500 naming conventions.

In order to associate these application or system User IDs with an X.500 DN, multiple forms of a user, application or system identity are associated. For instance, associated with a DN may be mapping records to define a relationship between the X.500 DN and the user ID(s), which are known to the operating system or application user namespace. The presence of a set of mapping records, which associates an X.500 DN to an application or system user registry entry, implies the individual known by a X.500 DN has one or more accounts registered with the application or operating system which uses this registry. Assuming that these accounts are valid, a user, upon appropriate authentication, may access the system(s) or application(s) by the user IDs associated with the DN. Thus, the X.500 distinguished name is mapped or correlated to a user's accounts using a mapping record.

A number of these mapping records, which enable namespace translation, may be stored within a directory, security, application or operating system registry, which includes at least one mapping record for each carrier of a user's name, such as a X.509 digital certificate or other user identification that the authentication and access control system recognizes. If the X.500 distinguished name is recognized (i.e. contained in one of the mapping records), the id corresponding to that distinguished name is used to establish a network access environment, wherein the user is provided access to authorized entities on the network.

The use of mapping records eliminates the need for the user to authenticate with more than one entity (e.g., application, server) on the network, assuming that the network of applications and servers have a mutual trust relationship between them. In addition, the user id provided by the mapping record can be used to authorize the user's access rights to entities on the network. However, the use of mapping records and directory databases has several drawbacks. For example, the number of users that can be supported is limited by the number of mapping records that the database can handle. This drawback is exacerbated by the fact that the mapping records point to one and only one user id.

One way of solving this problem is by vectoring using chained mapping records. This is described in a U.S. patent application Ser. No. 09/507,882, entitled “Identity Vectoring Via Chained Mapping Records,” filed Feb. 22, 2000, which is hereby incorporated herein by reference in its entirety. With this technique, environmental factors have the effect of automatically vectoring the mapping process to its final selection and conclusion. This adds flexibility to the implementation of the identity mapping by allowing a mapping record to point to multiple user ids with the final selection of the mapping record to which the digital certificate will be mapped being based on network environmental factors. This works well in an environment where the user has a single identity to which many different id mappings take place.

This is insufficient, however, in a multi-organizational environment, in which multiple organizations are supported by a single user. In such an environment, it is disadvantageous to have the information regarding the user's role for various organizations linked. Thus, a need exists for a capability that separates the information for the various organizations. Further, a need exists for an enhanced capability to identify users in a network environment.

### SUMMARY OF THE INVENTION

The shortcomings of the prior art are overcome and additional advantages are provided through the provision of a method of creating identifiers of users of network environments. The method includes, for instance, providing a portion of an identifier, the portion being provided by a user of a network environment; and providing another portion of the identifier, the another portion being provided by a third party, and wherein the identifier is usable in identifying the user of the network environment.

In one example, the identifier is usable in identifying a context in which the user is using the network environment.

System and computer program products corresponding to the above-summarized methods are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1a depicts one embodiment of a network environment to incorporate and use one or more aspects of the present invention;

FIG. 1b depicts further details of the network environment of FIG. 1a, in accordance with an aspect of the present invention;

FIGS. 2a-2c depict the use of various connectors between a browser and a server of a network environment, in accordance with an aspect of the present invention;

FIG. 3 depicts one embodiment of using a virtual private network for conumunications between a browser and a server, in accordance with an aspect of the present invention;

FIG. 4 depicts one embodiment in which a user uses a smart card certificate in its access to a server, in accordance with an aspect of the present invention;

FIG. 5 depicts one embodiment of an environment in which wireless information is used to provide the physical location of a user, in accordance with an aspect of the present invention;

FIG. 6 depicts one embodiment of the logic associated with creating an identity, in accordance with an aspect of the present invention; and

FIG. 7 depicts one embodiment of the logic associated with using an identifier to obtain user attributes, in accordance with an aspect of the present invention.

### BEST MODE FOR CARRYING OUT THE INVENTION

In accordance with an aspect of the present invention, a capability is provided for identifying users of a network environment. As one example, a user identity includes two portions, one provided by the user and one provided by a third party. The portion provided by the third party is, for instance, unchangeable by the user. This identity describes various attributes relating to the user, including, for instance, business affiliations of the user. This identity is usable, for instance, in authenticating the user to a process (e.g., a server, application, network entity, firewall, router, etc.) of the network environment, as one example.

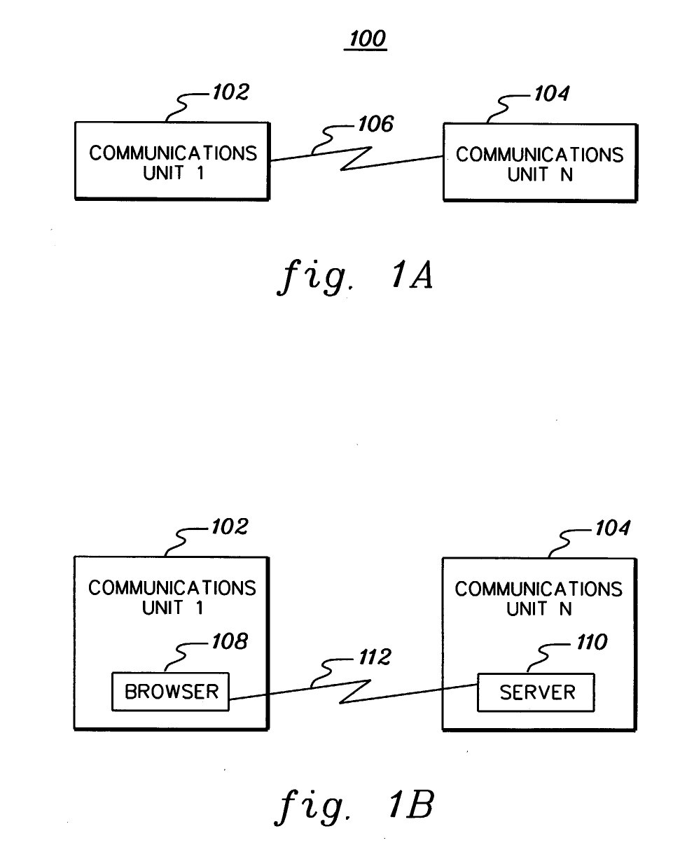

One embodiment of a network environment to incorporate and use one or more aspects of the present invention is described with reference to FIG. 1a. A network environment 100 includes, for instance, a communications unit 102 coupled to another communications unit 104 via a connection 106. A communications unit includes, for instance, a computing unit, such as a personal computer, a laptop, a workstation, a mainframe, a minicomputer, or any other type of computing unit. The communications unit can also be other than a computing unit, such as some other type of communications device, such as a smart card reader. Communications unit 102 may or may not be the same type of unit as communications unit 104. The connection coupling the units is a wire connection, or any type of network connection, such as a local area network (LAN), a wide area network (WAN), a token ring, an Ethernet connection, an internet connection, etc.

In one example, each communications unit executes an operating system, such as, for instance, the z/OS operating system offered by International Business Machines Corporation, Armonk, N.Y., a UNIX operating system, or other operating systems, etc. In other examples, one or more of the communications units need not include an operating system.

Further, in an embodiment described herein, communications unit 102 includes a browser application 108 (FIG. 1b) coupled to a server application 110 on communications unit 104. Browser 108 communicates with server 110 via, for instance, the hypertext transfer protocol (HTTP) 112 over a TCP/IP link coupling the units.

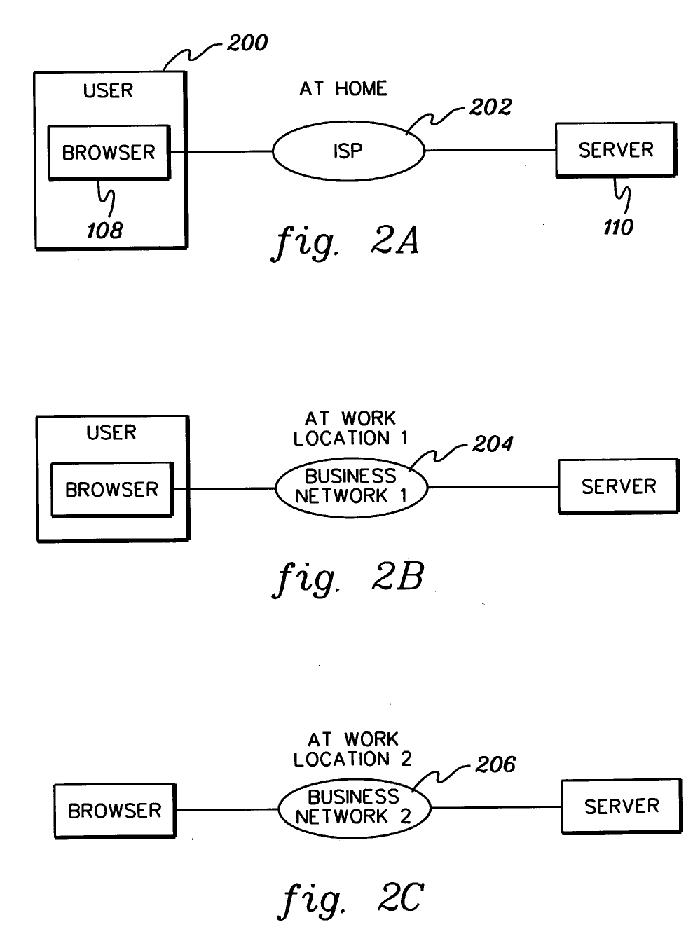

To facilitate communication between the browser and server, one or more connectors may be used. For example, as shown in FIG. 2a, a user 200 uses an internet service provider (ISP) 202 to issue requests between browser 108 and server 110. The user dials into the ISP, and then using its browser, enters a user id and password (and/or other identifying information). It also provides an identification of the server (e.g., a URL, internet protocol (IP) address, or other designation) to be accessed. The ISP defines an IP address (e.g., 102.53.16.40) for the browser.

As a further example, the user dials directly into a business network 204 (FIG. 2b). Again, using its browser, the user provides a user id, password, and server identification. The user id and password are the same as in the example depicted in FIG. 2a. In this case, however, it is the business that issues an IP address (e.g., 32.5.160.4) for the browser. The address is particular to that business, and is not known by the user. It is created by or for the business.

Similarly, in FIG. 2c, the same user logs on using the same id and password, but dials into a different business 206. Again, in this scenario, the business provides the IP address (e.g., 75.25.60.104) for the browser.

In accordance with an aspect of the present invention, a user's identity includes not only information provided by the user, but also information provided by a third party, such as an ISP, business, an access device or other parties. For instance, in the ISP example, the user's identity includes one portion having information provided by the user, such as user id and/or password, and another portion having information provided by the ISP, such as the IP address provided by the ISP.

Similarly, in each of the business examples, the user's identity includes a portion having information provided by the user, and another portion having information provided by the business, such as the IP address created by or for the business. Thus, the user id not only identifies the user, but one or more other attributes of the user, such as business affiliation (e.g., employment information), etc.

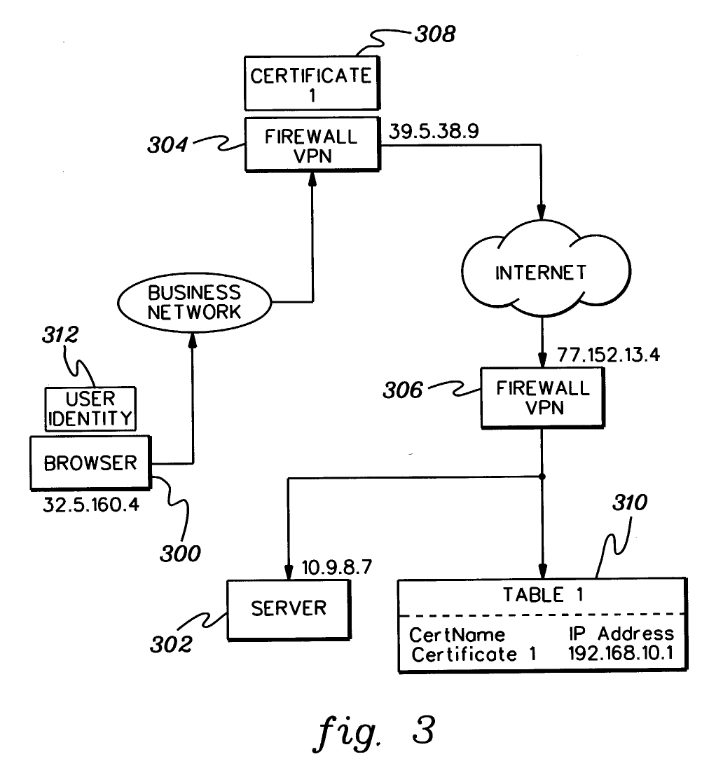

In addition to the above examples for creating a user's identity, other examples are described below. For instance, in FIG. 3, a browser 300 communicates with a server 302 via a virtual private network (VPN). Virtual private networks are used to ensure identities of businesses. This is particularly useful in those situations in which dynamic address allocation, such as Dynamic Host Control Protocol (DHCP), is used to dynamically define IP addresses for users, and thus, the identification of exact addresses for a particular user becomes problematic.

A VPN is established via a business by building connections between firewalls. End points in the firewalls are identified by certificates. By using these certificates, certificate definitions can be mapped to locally administered addresses. Most firewalls use Network Address Translation (NAT) to separate internal addresses from external addresses. This allows a user community to hide their addresses from the internet. It also allows multiple users to use a single external IP address. In the example of FIG. 3, a firewall 304 at 39.5.38.9 contacts a firewall 306 at 77.152.13.4. During an Initial Key Exchange (IKE), the destination firewall 306 inspects a certificate (e.g., Certificate 1) 308 associated with firewall 304. The destination firewall associates this particular VPN with a particular certificate.

When the user accesses the server, it goes through the VPN to the server. At the destination firewall, a table 310 is consulted. The table is located, for instance, in the firewall and identifies the certificate of the VPN and associates the request to a particular IP address. The server can also consult the table to determine the business associated with the IP address (e.g., 192.168.10.1). When the browser makes the request, it passes a user identity 312 (e.g., user id certificate) over the VPN. When the request reaches the server, it comes across the IP address defined by the VPN. For instance, the original IP address of the browser is 32.5.160.4, but to the server, it appears that the IP address is 192.168.10.1. Thus, the user's identity includes the user information (312) and the IP address associated with Certificate 1.

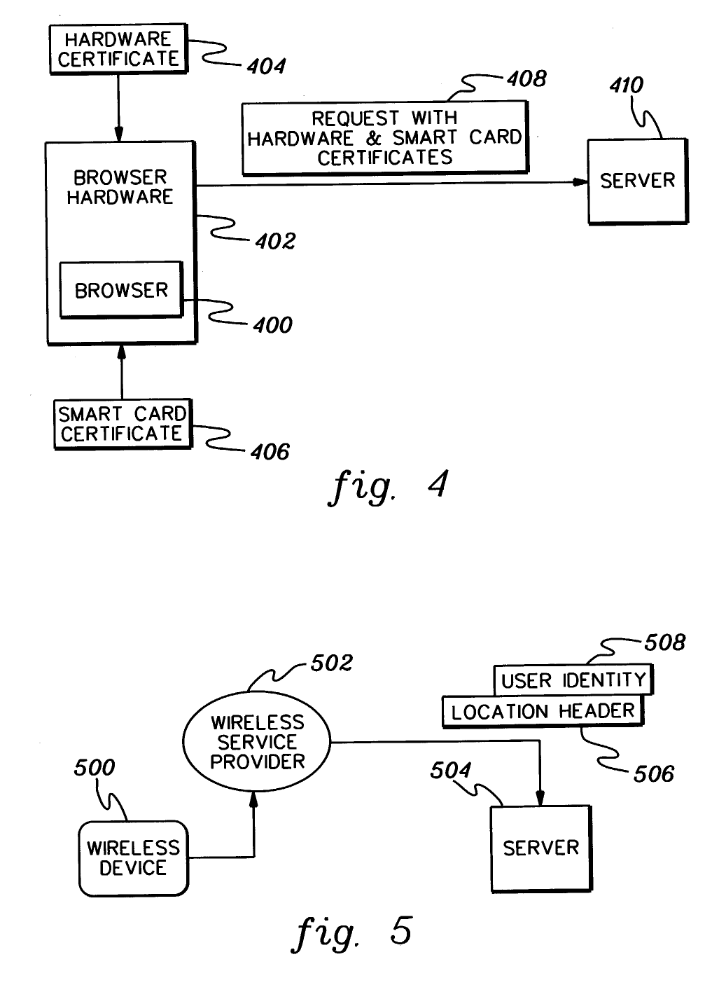

As a further example, multiple certificates may be used to create a user's identity. One of the certificates is under the user's control, while another is not. This is further described with reference to FIG. 4. In this example, the user is separated from the actual machine that is running the browser. Instead, the user employs a smart card reader or similar device to identify the user. A browser 400 is running on browser hardware 402, such as an operating system. Associated with the hardware is a hardware certificate 404 that is outside of the user's control (e.g., in a cache inaccessible to the user). The user provides the hardware with a digital certificate, or key from the smart card 406. The browser hardware uses both certificates in sending a request 408 to a server 410. Thus, the user's identity includes information from the hardware certificate out of the user's control, as well as information from the smart card, such as a digital certificate, which is in the user's control.

The above implementation is useful, for instance, when workstations are statically placed (physically located) within a business or organization unit, and addresses users which are mobile, using a workstation or mobile device which contains digital certificates which are not directly accessible by the user of the mobile device, and a smart card or similar device which is within the user's scope of control. For example, if a user has the smart card which includes a digital certificate and key material, an access device, such as a mobile computer, the digital certificate contained within the smart card or resident on the mobile device forms one portion of an identity, which is valid to access a corporate server.

The digital certificate tied to the hardware, which forms the second portion of a valid identity, is not directly accessible by the user. The process responds to an identity that is tied to the combination of certificates. Businesses with employees who have roaming certificates could use this implementation to ensure that those certificates are only used from specific machines regardless of IP addressing assigned to the hardware via DHCP. This would prevent a user from using the smart card or mobile device to access secure information (e.g., business data or business applications) from a remote location, such as their place of residence. This is particularly useful to businesses that require physical security in addition to user identification, such as in the healthcare industry.

In yet another implementation, location can play a part in identifying the user, and the user's location is provided by a third party. Thus, multiple parties work together to certify the location and identity of a user. With this implementation, a third party is responsible for identifying the location of the user and provides this information to the service provider, as described with reference to FIG. 5.

In FIG. 5, a wireless device 500, such as a cell phone, uses a third party provider 502 to access a server 504. The third party provides triangulation information 506 to the server, along with a user's request and identity information 508 provided by the user. The location information is certified by the provider and attached to the request without the user's intervention. This would be valuable for mobile users whose geophysical location facilitates in determining identity.

In a further implementation, the third party is an access device, in which the third party portion of the identity is part of the device itself (e.g., burned in at point of manufacture). Examples of such devices include mobile computers, PDAs, etc. In this implementation, the identity is based on an access portal.

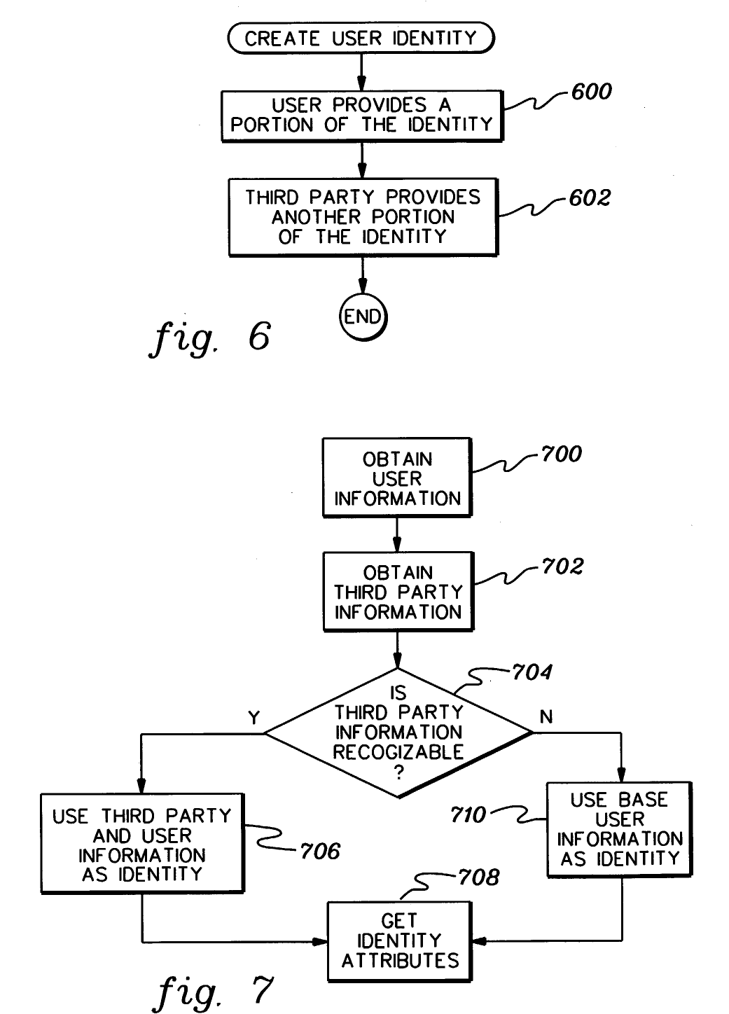

As described above, a user's identity is defined based on at least two pieces, one provided by a user, STEP 600 (FIG. 6) and one provided by a third party, STEP 602. Provided by a user indicates that the user provides the information or it is under at least some control of the user (e.g., accessible to the user). The information provided by the user can include many types of information, including, but not limited to, user ID, password, digital certificates or some other challenge response mechanism. Provided by a third party indicates that it is out of the control of the user (e.g., inaccessible to the user). It can be created by or for the third party, or otherwise available to the third party.

The identity can be used as a component of an authentication or access control mechanism for processes to determine, for instance, in what capacity or context a particular user is contacting the process. For example, the process can determine whether it is being contacted by the user as a private entity (e.g., an entity, such as an individual, not associated with the organization using or owning the server; a non-employee; non-contractor; non-worker; etc.) or as an entity that is associated with or has a relationship with the organization owning or using the process (e.g., an employee, contractor, worker, business affiliate, etc.). One example of the manner in which this determination is made is described with reference to FIG. 7.

Initially, the user's information is obtained, STEP 700. As examples, this includes information entered by a user on a browser or information retrieved from a user's certificate. Additionally, third party information is obtained, STEP 702. This information can be obtained from, for instance, an IP address, a machine certificate, a location header, etc.

Thereafter, a determination is made as to whether the third party information is recognizable by the process, INQUIRY 704. That is, is the IP address recognized by the process as one that it has issued or has some control over. If so, then the user information and the third party information is used as the identity, STEP 706. This identity is used as an index into a database to retrieve one or more attributes regarding the user, STEP 708.

If, on the other hand, the third party information is not recognizable, INQUIRY 704, then the base user information is used as the identity, STEP 710, to obtain one or more attributes regarding the user, STEP 708.

In one example, to obtain the attributes, the identity is used as an index into a database, such as an LDAP database. The LDAP database is shared by multiple organizations in one or more companies, which have established a business relationship. In particular, the identity is a distinguished name that points to a record having attributes associated with that particular name. That record does not include attributes not relevant to that name. For instance, an identity that identifies a user, User A, being employed by Company X would not have access to information for User A being employed by Company Y. The public information for the user resides in the attributes associated with the user's LDAP Distinguished Name, which may include public permission information. This information is maintained in the LDAP directory database which is available to the business partners, and thus, the scope of public information is information which may be accessed only by the business partners. More detailed, or sensitive user privileges, access rights, etc. may be derived from the user's LDAP DN, which are not visible outside of the administrative or organizational domain of a given business unit. The more privileged permissions are associated with the derived distinguished name (i.e., the multi-portion identity) maintained by the registry.

The records need not all be in one database, but can be included in multiple databases. These records need not be logically linked or chained, since one identity need not know about the other identities associated with a given distinguished name. A particular identity identifies who the user is as far as a particular entity is concerned (e.g., as a private individual, as an employee of a specific company, etc.). Further, a derived identity may define a user in the context of where the user is physically located. The process (e.g., server application, network accessible entity, firewall, router, etc.) uses the attributes retrieved from a database or similar registry to determine a context or capacity that the user is accessing the process (e.g., as a private individual, as an employee, etc.).

Advantageously, the identification capability of one or more aspects of the present invention provides a more secure identity. For instance, information regarding a user in a particular context is only available to those of that context. Also, in the case of part of the information being based on location, the identity prevents certain actions from being taken unless in a particular location.

As a specific example, the identification capability of one or more aspects of the present invention renders user identities stolen from physically secured locations as useless. Users are identified as valid only when occurring within a certain address context. This is valuable in many industries, including, for instance, the health care industry, home banking, financial banking, e-commerce, etc.

Advantageously, the identifier is usable in qualifying the organizational, administrative and/or geographic boundary that the user is a part of in the environment.

Although various embodiments are described above, these are only examples. For instance, although examples of network environments are described herein, other environments may incorporate and use one or more aspects of the present invention. Further variations are possible. For instance, in the above example that describes the virtual private network, multiple firewalls can be employed. The depiction of two firewalls is only one example. Yet further, although the example described herein is for a multi-organizational environment, this is only one example. One or more aspects of the present invention can be used for environments other than multi-organizational environments. Further, although various of the examples are described with reference to a server, these are only examples. Other processes, such as applications, network entities, routers, firewalls, etc., may benefit from one or more aspects of the present invention.

One or more aspects of the present invention can be implemented in software, firmware, hardware or some combination thereof.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of creating identifiers of users of network environments, said method comprising:
providing a portion of an identifier, said portion being provided by a user of a network environment; and
providing another portion of the identifier, said another portion being provided by a third party, and wherein the identifier is usable in identifying the user of the network environment.

2. The method of claim 1, wherein the identifier is usable in identifying a context in which the user is using the network environment.

3. The method of claim 1, further comprising using the identifier, by a process, to determine a context in which the user is accessing the process.

4. The method of claim 3, wherein the using comprises determining whether the another portion of the identifier is recognizable by the process, wherein a result of the determining indicates the context.

5. The method of claim 4, wherein recognization by the process of the another portion of the identifier indicates a relationship between the user and an organization using the process.

6. The method of claim 4, wherein non-recognition of the another portion of the identifier indicates the user is accessing the process as a private entity.

7. The method of claim 1, further comprising using the identifier to obtain one or more attributes of the user.

8. The method of claim 7, wherein the one or more attributes include business affiliation of the user.

9. The method of claim 1, wherein the third party is a business.

10. The method of claim 1, wherein the third party is a service provider.

11. The method of claim 10, wherein the service provider comprises an internet service provider.

12. The method of claim 10, wherein the service provider comprises a wireless service provider.

13. The method of claim 1, wherein the third party is an access device.

14. The method of claim 1, wherein the another portion comprises location information.

15. The method of claim 1, wherein the another portion comprises information from a hardware certificate.

16. The method of claim 1, wherein the another portion comprises information from a certificate associated with a virtual private network.

17. The method of claim 1, wherein the network environment is a multi-organizational environment.

18. A system of creating identifiers of users of network environments, said system comprising:
means for providing a portion of an identifier, said portion being provided by a user of a network environment; and
means for providing another portion of the identifier, said another portion being provided by a third party, and wherein the identifier is usable in identifying the user of the network environment.

19. The system of claim 18, wherein the identifier is usable in identifying a context in which the user is using the network environment.

20. The system of claim 18, further comprising means for using the identifier, by a process, to determine a context in which the user is accessing the process.

21. The system of claim 20, wherein the means for using comprises means for determining whether the another portion of the identifier is recognizable by the process, wherein a result of the determining indicates the context.

22. The system of claim 21, wherein recognization by the process of the another portion of the identifier indicates a relationship between the user and an organization using the process.

23. The system of claim 21, wherein non-recognition of the another portion of the identifier indicates the user is accessing the process as a private entity.

24. The system of claim 18, further comprising means for using the identifier to obtain one or more attributes of the user.

25. A system of facilitating identification of users of network environments, said system comprising:
a communications unit to use an identifier to identify a user of the network environment, wherein the identifier comprises a portion of the identifier being provided by a user of the network environment and another portion of the identifier being provided by a third party.

26. At least one program storage device readable by a machine embodying at least one program of instructions executable by the machine to perform a method of creating identifiers of users of network environments, said method comprising:
providing a portion of an identifier, said portion being provided by a user of a network environment; and
providing another portion of the identifier, said another portion being provided by a third party, and wherein the identifier is usable in identifying the user of the network environment.

27. The at least one program storage device of claim 26, wherein the identifier is usable in identifying a context in which the user is using the network environment.

28. The at least one program storage device of claim 26, wherein said method further comprises using the identifier, by a process, to determine a context in which the user is accessing the process.

29. The at least one program storage device of claim 28, wherein the using comprises determining whether the another portion of the identifier is recognizable by the process, wherein a result of the determining indicates the context.

30. The at least one program storage device of claim 29, wherein recognization by the process of the another portion of the identifier indicates a relationship between the user and an organization using the process.

31. The at least one program storage device of claim 26, further comprising using the identifier to obtain one or more attributes of the user.
